(19) United States
(12) Patent Application Publication
(10) Pub. No.: US 2010/0017280 A1
(43) Pub. Date: Jan. 21, 2010

(54) ADVERTISING SYSTEM AND PROCESS

(76) Inventors: Martin James Davis, Oxon (GB); Sacha Gaston M. Vekeman, Gent (BE)

Correspondence Address: FAY SHARPE LLP, 1228 Euclid Avenue, 5th Floor, The Halle Building, Cleveland, OH, 44115, US

(21) Appl. No.: 12/306,390

(22) PCT Filed: Jun. 22, 2007
(86) PCT No.: PCT/GB07/02337

§ 371 Date: Dec. 23, 2008

(30) Foreign Application Priority Data
Jun. 23, 2006 (GB) 0612395.4

(51) Int. Cl. G06Q 30/00; G06F 17/30; H04M 3/42; H04M 11/00

(52) U.S. Cl. 705/14.4; 707/104.1; 707/E17.005; 455/414.1; 455/406

(57) ABSTRACT

An advertising system and process that allows private individuals and traders to place, view and respond to classified advertisements using a mobile phone (or cell phone) network.

The present invention relates to an advertising system and process, and in particular but not exclusively to a system that allows private individuals and traders to place, view and respond to classified advertisements using a mobile phone (or cell phone) network.

For many years, newspapers have published classified advertisements for a wide variety of products and services, typically under headings such as Automotive, Real Estate, Employment, Merchandise and Personals. The advertisements may relate for example to items that are being offered for sale by members of the public, such as cars, houses or personal possessions, or to services that are being offered to the public, such as domestic cleaning services, repair and maintenance services, and so on. Non-commercial advertisements and notices may also be included, for example personal contact or “lonely hearts” advertisements. Usually, the advertisement includes a telephone number or a box number, which allows members of the public to respond to the advertiser. Any subsequent negotiations and transactions are then conducted between the responder and the advertiser, without any involvement from the newspaper.

Although the newspaper-based classified advertising system has operated successfully for many years, it does have a number of limitations and drawbacks. First, the system is generally very slow, being driven by the printing schedule of the newspaper. It may therefore take several days for an advertisement to be published. The classification system used by newspapers also tends to be static and does not readily reflect changes in technology or society. Further, because responders cannot readily filter the results to identify those advertisements in which they might be interested, except by using the limited classification system, the buyer may have to sift through a large number of advertisements before finding any to which they wish to respond. Further, because of space constraints within the newspaper and other factors such as digital image quality, it may not be possible to publish a photograph with the advertisement. It is also usually not possible for a potential responder to filter results by geographical location, even though this may be a significant factor in determining whether or not the responder wishes to respond to a particular advertisement.

It is an object of the present invention to provide an advertising system that mitigates at least some of the aforesaid disadvantages.

According to the present invention there is provided an advertising system including a server having a database for storing details of advertisements, publishing means for publishing details of the advertisements, and electronic communication means allowing the server to communicate with advertisers and responders, said system being constructed and arranged such that advertisers can place advertisements on the system and responders can view the published details of the advertisements, wherein the server is constructed and arranged to enable communication between an advertiser and a responder upon receiving a response from the responder that identifies an advertisement placed by the advertiser.

In summary, one aspect of the invention provides a system for posting, listing and responding to advertisements via electronic communications. This aspect of the invention is referred to herein as a posting, listing and responding (PLR) system.

The system allows classified advertisements to be placed and viewed electronically, which avoids the delays inherent in printed advertisements. It also allows the advertisements to be searched in a variety of different ways, for example using the classification structure, one or more keywords, or by location or date. Because communication between an advertiser and a responder is enabled only after a responder has filed a valid response, the risk of nuisance calls and time wasting responses is reduced. The system is accessible from anywhere, providing that the responder has a suitable communications device, for example a mobile phone. It also allows graphics (e.g. photographs or video clips) or audio clips to be included in the advertisements. The system also provides a straightforward method of billing users, allowing it to be run as a successful commercial venture.

Advantageously, the server includes a dynamic classification system (DCS) for classifying advertisements placed on the system, wherein the DCS is constructed and arranged to allow each advertiser to specify one or more tags that are to be attached to that advertiser's advertisement. A dynamic classification system based on tags specified by the advertisers provides far greater flexibility than a traditional taxonomy-based classification system and allows more efficient searching by potential responders. The system is also able to adapt rapidly to changing market conditions such as short term fluctuations in demand and supply (for example, the sale of tickets to a concert or other event), and advances in technology, resulting in new kinds of product being offered for sale.

Preferably, the DCS is constructed and arranged to record all the tags associated with advertisements placed on the system, to obtain a popularity value for each recorded tag that represents the number of advertisements associated with that tag, to rank the tags according to their popularity values and to display one or more of the tags having the highest popularity values. This allows users to assess the level of supply for items and services that are currently being offered in advertisements on the system, and to identify the tags that are being used most frequently to identify those items. This reduces one of the disadvantages most commonly associated with folksonomy-based classification systems, which is that such systems can be unreliable owing to the fact that different users may choose different tags for similar items, or similar tags for different items. By allowing users to see easily which tags are most popular, advertisers and responders can choose to select those tags, so ensuring a degree of uniformity and consistency among users.

Preferably, the DCS is constructed and arranged to record all the tags associated with advertisements placed on the system, to obtain a wanted value for each recorded tag that represents the number of responses to advertisements associated with that tag, to rank the tags according to their wanted values and to display one or more of the tags having the highest wanted values. This allows users to assess the level of demand for items and services that are currently being offered in advertisements on the system, and to identify the tags that are being used most frequently to identify those items. This is useful for advertisers with items to sell, as it allows them to assess the current level of demand for those items and set a price accordingly. It also allows them to see easily which tags are most likely to generate responses.

The number of tags associated with an advertisement may include tags attached to that advertisement and one or more additional tags that are related to the attached tags. In other words, the system may be arranged to recognise certain specified tags and associate those tags with one or more related tags, such as synonyms or tag clusters. This is increases the power of the system as a search and research tool by reducing the reliance on consistency between users in their choice of tags for particular items and services.

Advantageously, the communication means is constructed and arranged to allow the server to communicate with advertisers and responders by means of data communication through a mobile phone network. The data communications may for example consist of SMS or MMS messages.

The server may be constructed and arranged to identify advertisers and responders according to their mobile phone numbers. The mobile phone numbers can be identified automatically by the mobile phone network. As all mobile phone numbers are unique, this provides an easy method for identifying users. It also allows for easy billing, by charging premium rate call charges for sending and/or receiving messages (that is, for mobile originated and/or mobile terminated messages).

The server may be constructed and arranged to identify the geographical location of advertisers using mobile data services (i.e. location based services). This provides advertisers with an option for including geographical location data automatically in the advertisement, and the system operator with another billing opportunity.

Advantageously, the server includes billing means that is constructed and arranged to charge for use of the system by charging advertisers and/or responders for sending and/or receiving data messages via the mobile phone network. This allows charges to be collected automatically without any further input from either the user or the system operator.

The publishing means may be constructed and arranged to push details of advertisements to responders via the mobile phone network, for example as RSS feeds.

Advantageously, the server is configurable to publish personal contact details allowing direct communication between the advertiser and the responder, or to hide those details, or to provide those details only in specific circumstances. In some circumstances, the advertiser may wish to include personal contact details such as mobile phone number in the advertisement, allowing the responder to contact the advertiser directly. In other cases, the advertiser may prefer to withhold that information from the public advertisement and provide it only to responders who make a valid response. In other circumstances (for example, in the case of a personal advertisement), the advertiser may prefer to permanently hide all personal contact details. In this case, all communication between the advertiser and the server may be relayed through the server. Similarly, the responder may choose to disclose or hide personal contact information.

Alternatively or in addition, the publishing means may be constructed and arranged to publish details of advertisements via the internet or by any other suitable electronic or non-electronic medium, for example by printed publication or through television or the mobile phone network.

Advantageously, the stored details include public data and hidden data, the server being constructed and arranged to provide hidden data to a responder only upon receiving a response from the responder. This controls use of the system and provides the system operator with a billing opportunity.

The published details of each advertisement may include a unique identification code, which is included in all valid responses from users of the system.

The server may be constructed and arranged to categorise advertisements automatically. It may also be arranged to generate a classification system based on data contained in the advertisements. This provides for a flexible and dynamic classification system (DCS) that adapts automatically to the changing use of terminology and tags. It can also be carried out automatically, thereby reducing costs for the service provider. A suitable process may for example be based on the principles of folksonomy.

The server may be constructed and arranged to generate search tags automatically for the advertisements. These may be added to the advertisement at the option of the advertiser, to permit easier searching. It also provides another billing opportunity.

Advantageously, the system is constructed and arranged to record data relating to use of the system, and to generate reports based on measurement of the recorded data. This makes it possible to measure responses and interactions for individual advertisements, allowing advertisements to be ranked, for example by popularity, price or location.

The server may allow responders to forward advertisements to third parties, thus increasing its usefulness to consumers.

Advantageously, the advertising system includes a social valuation system (SVS) that allows users to attach a social value to advertisements.

According to another aspect of the invention there is provided an advertising process including receiving advertisement details from advertisers, storing the advertisement details in a database, publishing details of the advertisements, receiving responses from responders, and allowing communication between an advertiser and a responder upon receiving a response from the responder that identifies an advertisement placed by the advertiser.

Advantageously, the advertising process includes classifying advertisements placed on the system by allowing each advertiser to specify one or more tags and attaching the tags to that advertiser's advertisement.

Advantageously, classifying the advertisements includes recording all the tags associated with advertisements placed on the system, obtaining a popularity value for each recorded tag that represents the number of advertisements associated with that tag, ranking the tags according to their popularity values, and displaying one or more of the tags having the highest popularity values.

Advantageously, classifying the advertisements includes recording all the tags associated with advertisements placed on the system, obtaining a wanted value for each recorded tag that represents the number of responses to advertisements associated with that tag, ranking the tags according to their wanted values, and displaying one or more of the tags having the highest wanted values.

The number of tags associated with an advertisement may include tags attached to that advertisement and one or more additional tags that are related to the attached tags.

The server may communicate with advertisers and responders via data communications transmitted through a mobile phone network.

The process may include identifying advertisers and responders according to their mobile phone numbers.

Advantageously, the process includes identifying the geographical location of advertisers using mobile data services.

Advantageously, the process includes billing for use of the process by charging advertisers and/or responders for sending and/or receiving data messages via the mobile phone network.

The process may include publishing by pushing details of advertisements to responders via the mobile phone network. Alternatively or in addition it may include publishing details of advertisements via the internet.

Advantageously, the server is configured to publish personal contact details allowing direct communication between the advertiser and the responder, or to hide those details, or to provide those details only in specific circumstances.

The stored details may include public data and hidden data, the hidden data being provided to a responder only upon receiving a response from the responder.

Advantageously, the published details of each advertisement include a unique identification code, which is included in all valid responses.

The process may include categorising advertisements automatically.

Advantageously, the process includes generating a classification system based on data contained in the advertisements.

The process may include generating search tags automatically for the advertisements.

Preferably, the process includes recording data relating to use of the system.

Advantageously, the process includes generating reports based on the recorded data.

Advantageously, the process includes allowing responders to forward advertisements to third parties.

Advantageously, the process includes a social valuation process, in which users attach social values to advertisements.

Certain embodiments of the invention will now be described by way of example with reference to the accompanying drawings, in which:

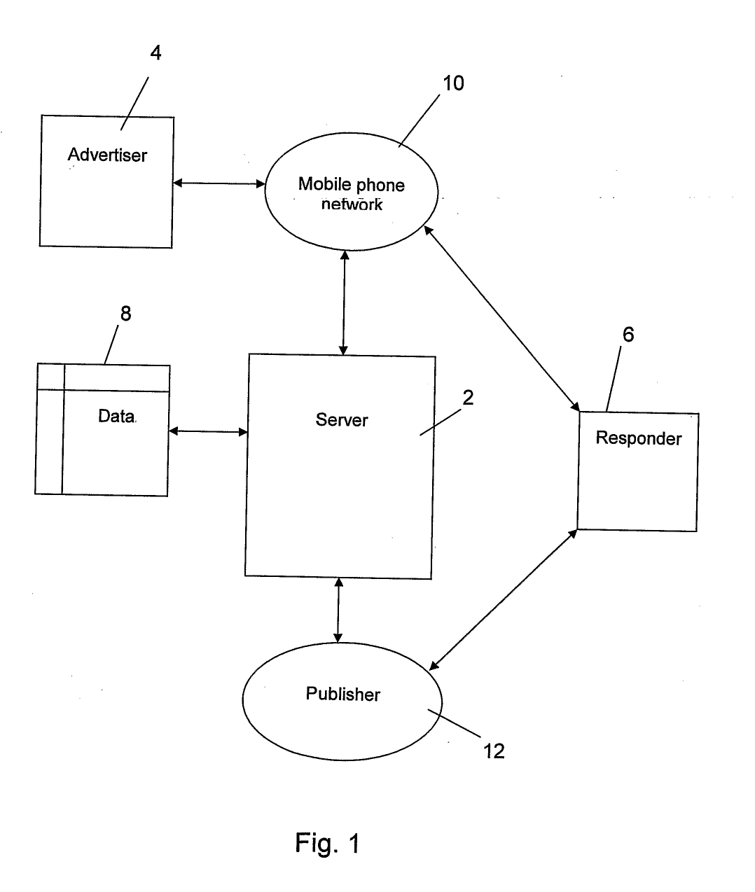

FIG. 1 is a schematic diagram of an advertising system infrastructure according to a first embodiment of the invention;

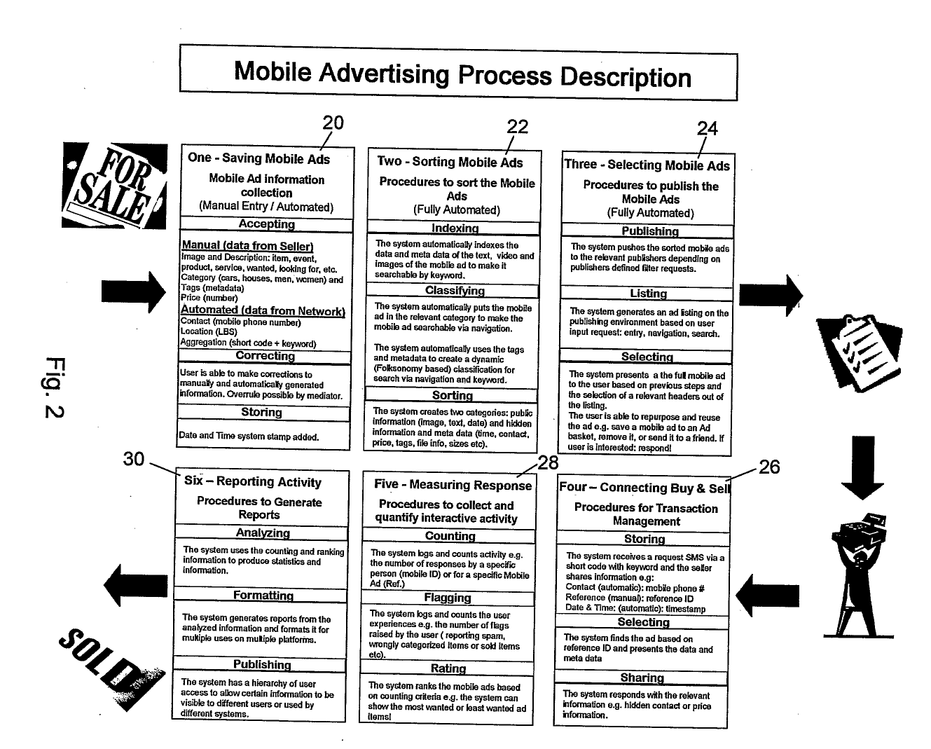

FIG. 2 illustrates schematically the mobile advertising process;

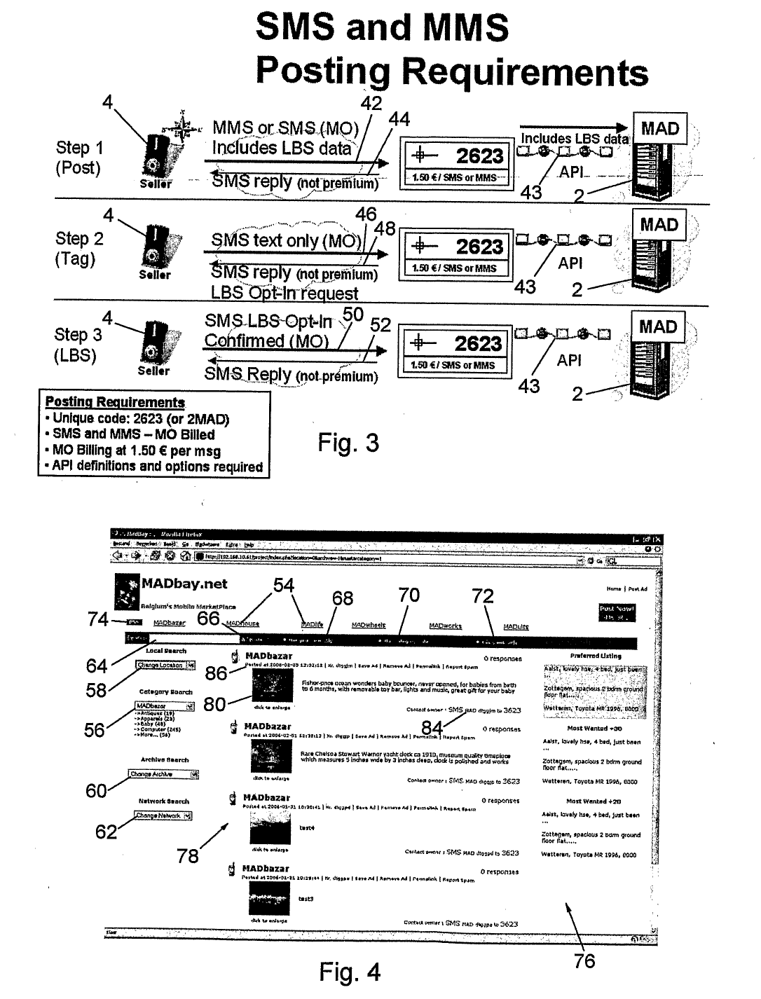

FIG. 3 illustrates schematically the steps of a process for posting an advertisement;

FIG. 4 illustrates a typical web portal for web-based advertisements, according to a first embodiment of the invention;

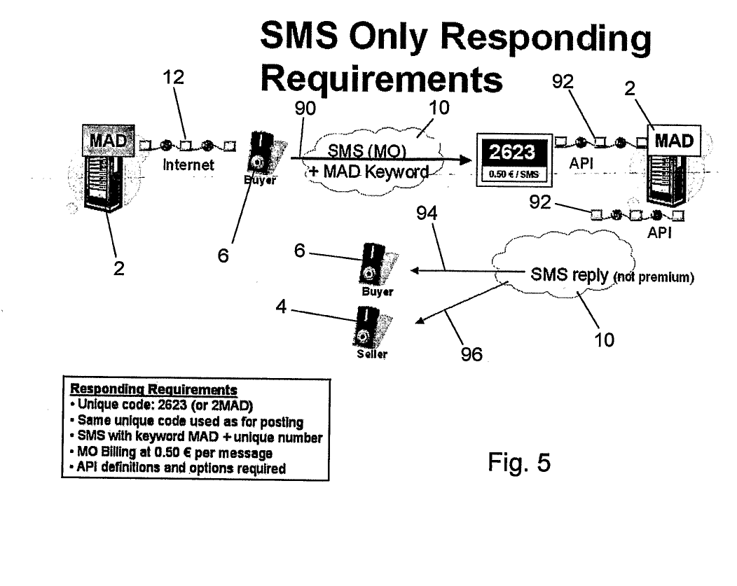

FIG. 5 is a flow diagram showing the steps of a process for responding to an advertisement, according to a first embodiment of the invention;

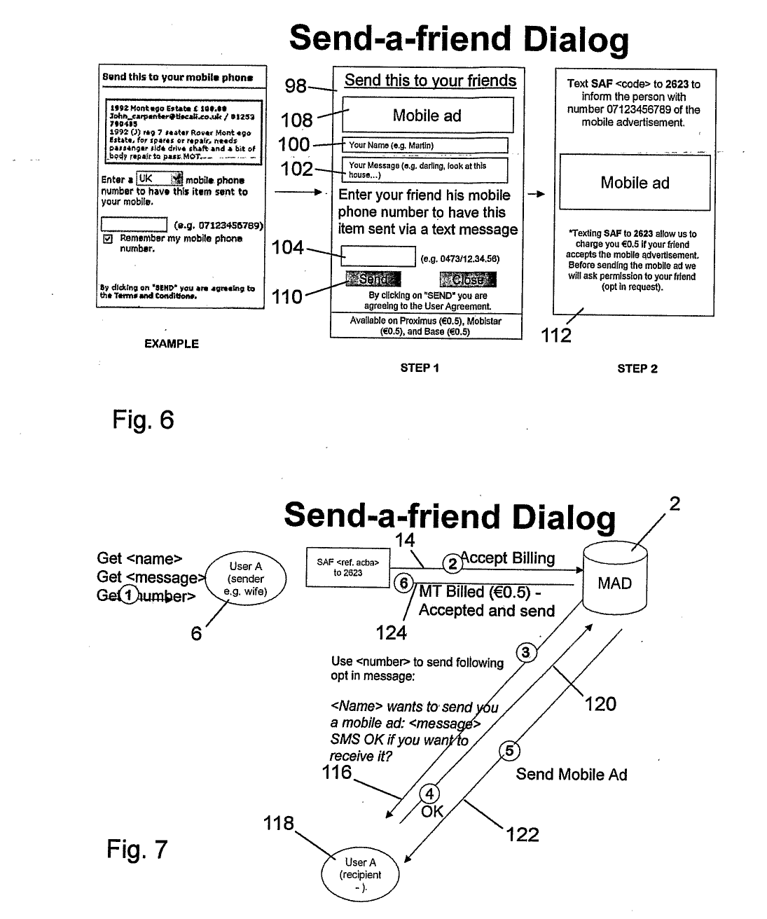

FIG. 6 and FIG. 7 illustrate a process for forwarding an advertisement to another person;

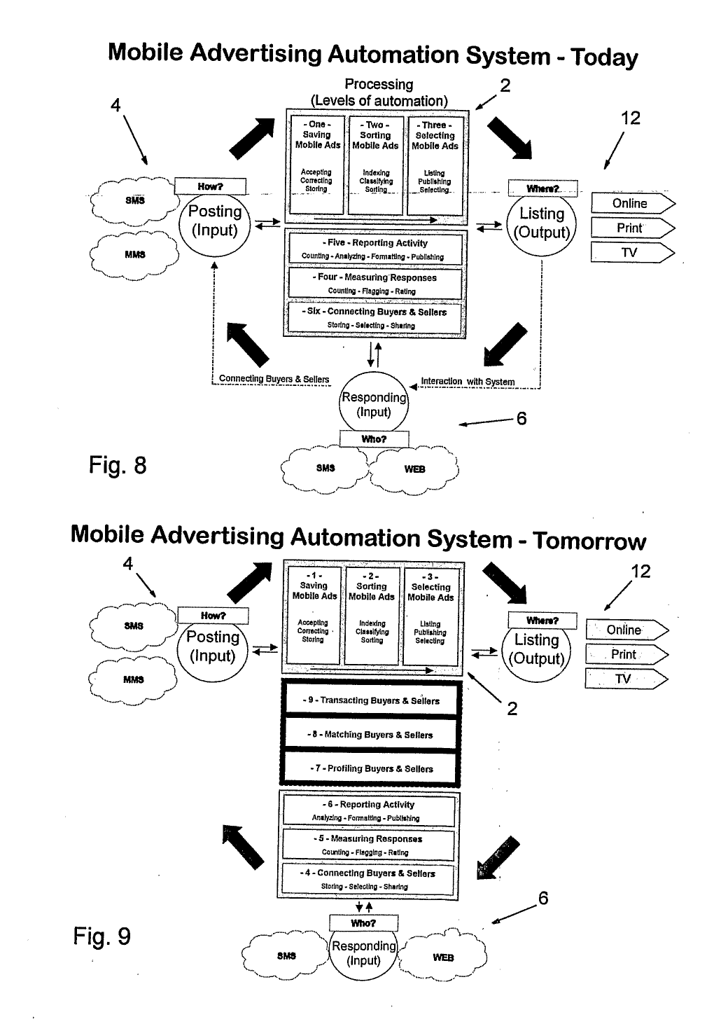

FIG. 8 is a system diagram illustrating operation of a first system according to the invention;

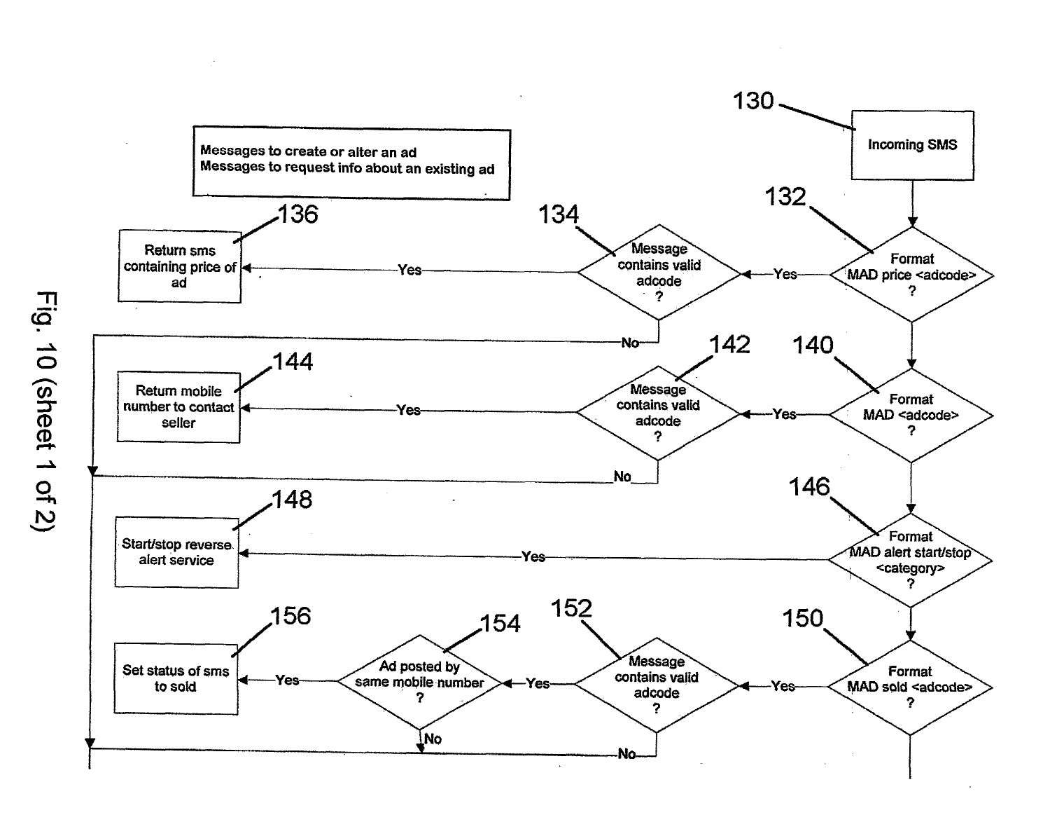

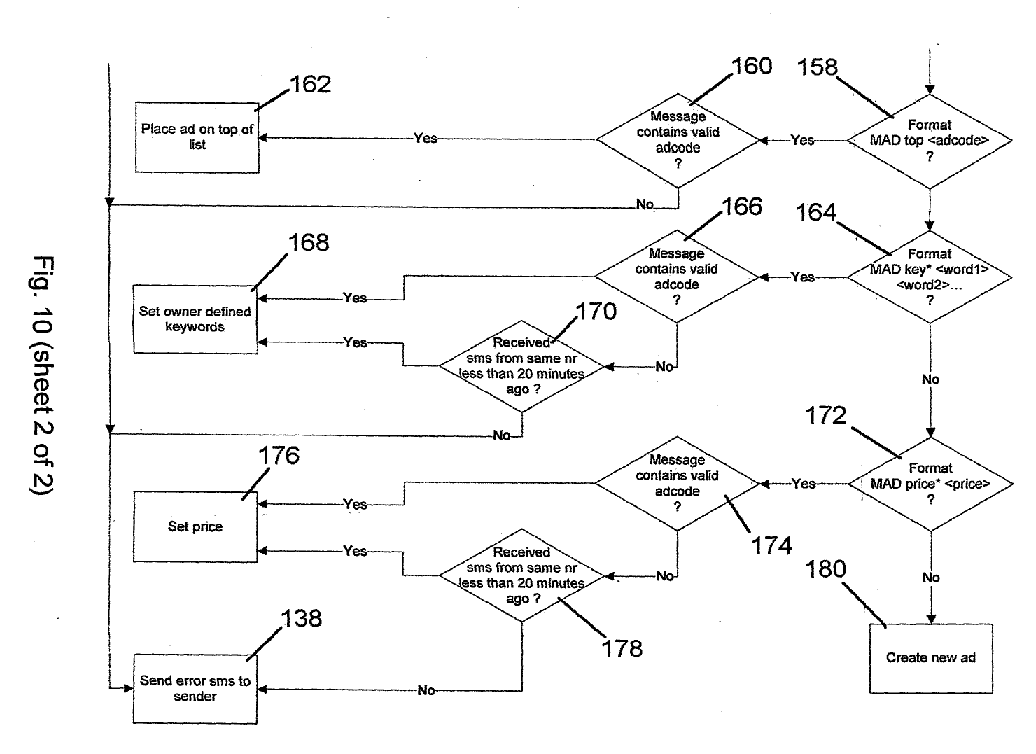

FIG. 9 is a system diagram illustrating operation of a second system according to the invention;

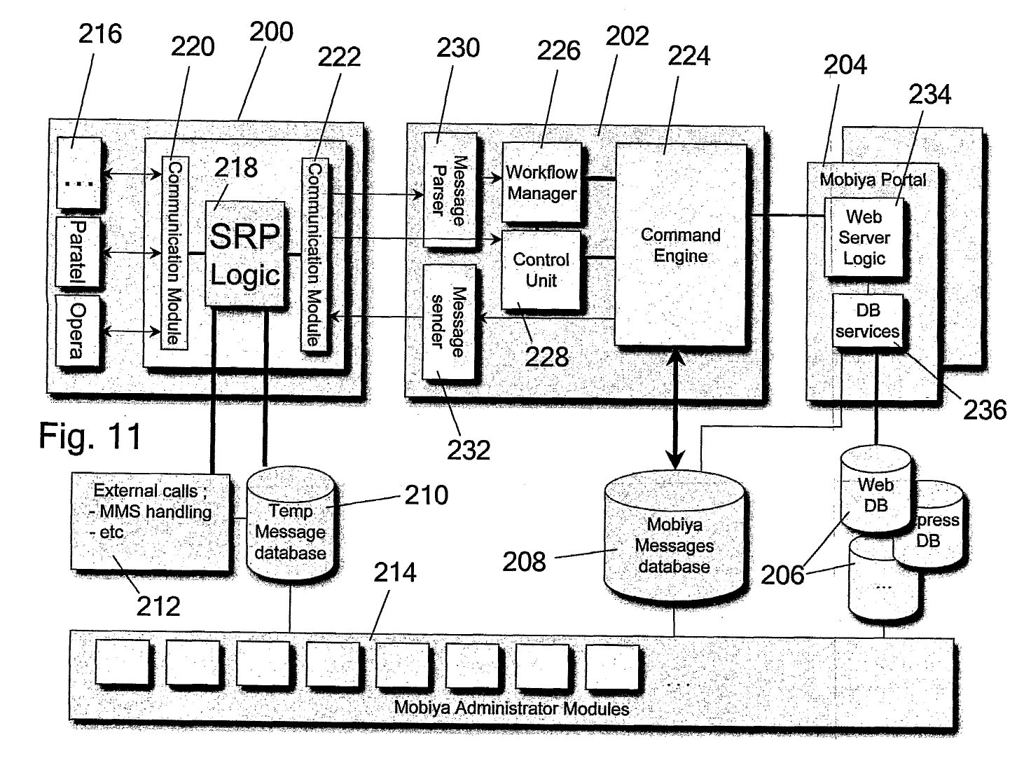

FIG. 10 is a flow diagram illustrating a process for handling incoming SMS text messages;

FIG. 11 is a schematic diagram of the advertising system infrastructure according to a second embodiment of the invention;

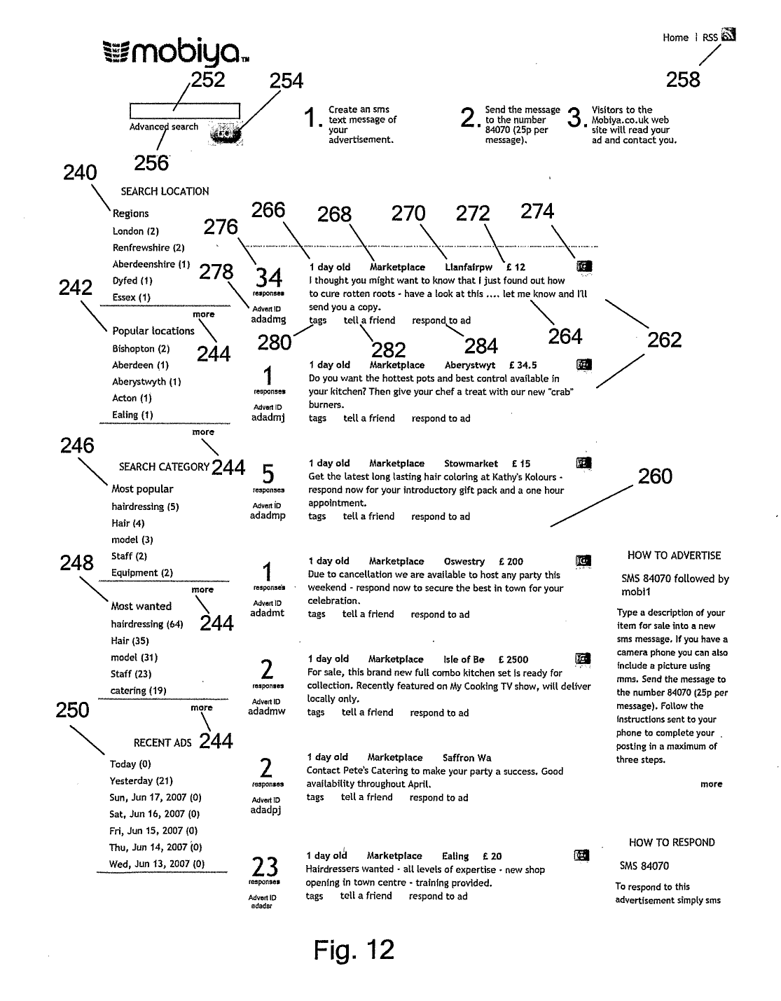

FIG. 12 illustrates a typical web portal for web-based advertisements, according to a second embodiment of the invention, and

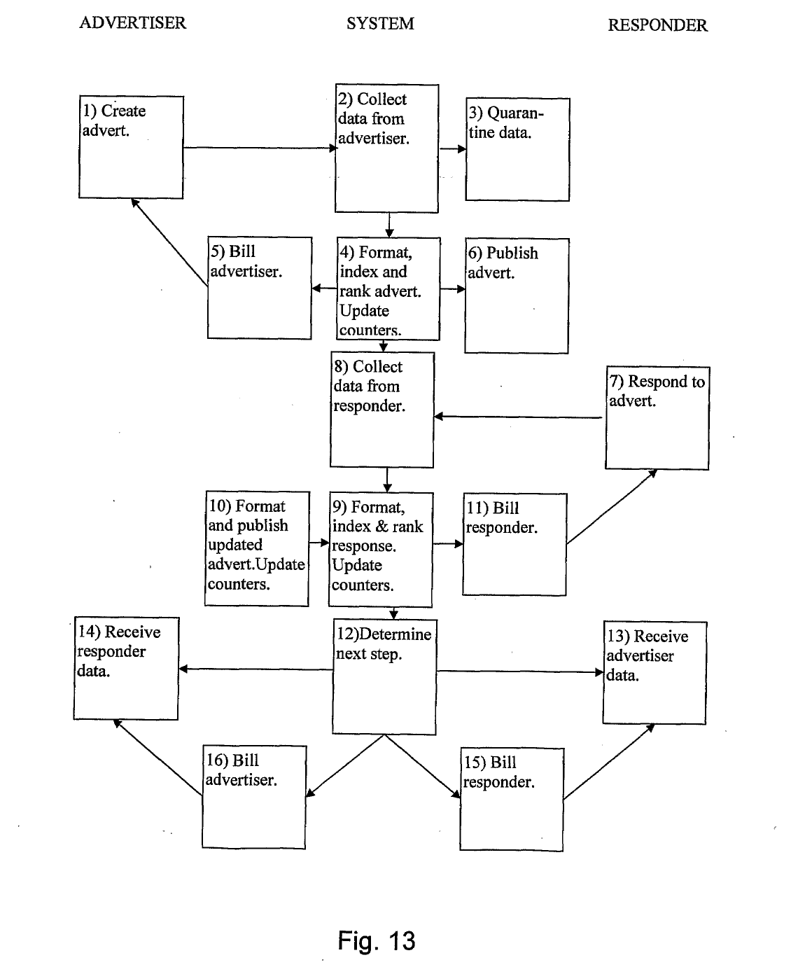

FIG. 13 is a flow diagram showing the steps of a process for placing and responding to an advertisement, according to a second embodiment of the invention;

The mobile advertising system shown in FIG. 1 includes a server 2, an advertiser 4 and a responder 6. The server 2 consists of a computer that is programmed to run the system. It is connected to a database 8.

The advertiser 4 represents one of a group of people who wish to place advertisements on the system. The advertiser may for example be someone who wishes to sell goods, to provide a service, or who wishes to place any other kind of public advertisement or notice, which may be either commercial or non-commercial in nature. For example, the notice may be a personal contact or “lonely hearts” message, placed by one person seeking a relationship with another person. The advertiser 4 has means for posting an advertisement on the system, for example a computer and/or a mobile phone (or cell phone).

The responder 6 represents one of a group of people who wish to view and respond to advertisements carried by the system. They may therefore wish to conduct a transaction with the advertiser or, in the case of a personal contact advertisement, simply arrange a meeting with the advertiser. The responder 6 also has means for viewing advertisements on the system, such as a computer and/or a mobile phone.

The advertiser 4 and the server 2 communicate with one another via the mobile phone network 10. The server 2 publishes advertisements via a publisher 12, which may for example be a website that is accessible through the internet, a printed advertisement or an advertisement published in any other way, for example by television. The responder 6 may view the advertisements via the internet or any of the other previously mentioned methods, or alternatively may arrange to receive advertisements via the mobile phone network 10, for example as SMS text messages. The responder 6 is able to communicate with the server 2 via the mobile phone network 10. The advertiser 4 and the responder 6 may also communicate with one another via the mobile phone network 10, once a valid response has been filed. The server 2 may be configured to provide contact information such as a mobile telephone number allowing direct communication between an advertiser and a responder, or it may be configured to provide a communication channel that allows SMS or MMS messages to be exchanged without revealing any personal contact details.

The advertising system thus provides a posting, listing, responding (PLR) system that allows users to post, list and respond to advertisements via a mobile phone network

The processes involved in operation of the mobile advertising system are shown schematically in FIG. 2. The major steps of those processes will now be briefly described.

The first step 20 of the advertising process is instigated by an advertiser (or seller) who wishes to place or post an advertisement on the system. The seller does this by sending a SMS (short message service) or MMS (multimedia message service) message to the server 2 via the mobile phone network 10. The message typically includes a description of the item, event, product or service that the seller is trying to sell, or of the kind of person the advertiser wishes to meet, together with a suitable image, audio clip or video clip where appropriate. The message also indicates the category in which the advertisement is to be placed (for example cars, houses, men or women), plus a number of keywords or “tags” (metadata) that the advertiser wishes to include in the advertisement for searching purposes. The advertiser also specifies the price, where this is appropriate. The server 2 stores this information in the database 8.

The server 2 also acquires information automatically from the mobile phone network 10, including the mobile phone number of the advertiser 4 and the geographical location of the advertiser by using location based services (LBS). This data is also stored in the database 8. The server 2 also allocates an identification code that is exclusive to that advertisement, and records the date and time of recording the advertisement. All of this information is stored in the database 8. Some of this data may be quarantined (hidden) so that it cannot be seen by users of the system.

The second step 22 comprises a process for automatically sorting the advertisements. The system automatically indexes the data and the metadata, including the text, video and images making up the advertisement, to make it searchable by keyword. In addition, the system automatically classifies the advertisement by putting it into the relevant category to make the advertisement searchable by navigation. A dynamic classification system (DCS) is automatically created, using the tags and metadata, by a process known as “folksonomy”. The classification system is searchable by navigation and/or by keyword.

The system also automatically sorts the data contained in the advertisement into the two categories: public information, such as text, date and image that is openly published and available to all users of the system, and hidden information and metadata such as time, contact details, price, tags, file information, size and so on that is either unpublished or is made available to responders only upon request.

The third step 24 comprises a process for publishing and selecting advertisements. The system automatically publishes and lists the advertisements; allowing responders to browse through the advertisements for items, services and so on in which they are interested. Only the public information (text, image and date) is published. The hidden information including the contact details of the advertiser is available to the responder only upon request. The responder cannot therefore contact the advertiser until that information has been provided.

Publication of the advertisements can take place via various routes. For example, the advertisements may be published via the internet allowing them to be searched through a web portal. The responder 6 is able to search by category, keyword or date, or a combination of these, in order to restrict the list of advertisements published to those in which the responder is interested.

Alternatively, the system can be arranged to generate a list of advertisements based on filters specified by a registered responder, and push the list directly to the responder as a feeds to an RSS (really simple syndication) reader, such as an email client or web browser.

The advertisements may also be published in other ways, for example in printed publications or by television.

If the responder requires more details about any of the advertisements, this will be provided automatically upon receiving a request, sent to the server by the responder as an SMS message, which includes the identification code of the required advertisement. The responder is then sent full details of the advertisement, optionally including the advertiser's contact details, as an SMS or MMS message. This allows the responder to respond to the advertisement.

The responder 6 is also able to re-use the advertisement: for example, the advertisement can be saved, removed from the list or forwarded to another person.

The fourth step 26 of the process consists of procedures for managing the transaction between the advertiser and the responder. The system receives a response from a responder via an SMS message, which includes an identification code identifying the requested advertisement. Upon receiving this response, the server in this embodiment automatically provides the responder with the advertiser's contact information, such as the advertiser's mobile phone number, as well as a date and time stamp. The seller may also allocate a reference identification to the response. This information is forwarded to the responder together with the data and metadata associated with the advertisement. This allows the advertiser and the responder to conduct the transaction without further interaction with the server. Alternatively, the server may be configured to relay SMS or MMS messages between the advertiser and the responder, allowing them to communicate without disclosing personal contact details.

The fifth step 28 of the process is provided by the social valuation system (SVS), which provides various social networking aspects of the mobile advertising service and allows the content of the system to be manipulated automatically according to the input of the users. In this step, the system automatically instigates procedures to collect and quantify interactive activity. This includes a counting process, in which the system logs and counts activity, for example the number of responses by a specific person (based on their mobile phone identification), or for a specific advertisement (based on the identification code of the advertisement). The system also logs and counts the number of user experiences, for example the number of flags raised by the user to report incorrect or inappropriate responses, for example to report spam, wrongly categorised items or items that have already been sold. The system also provides a rating system, which ranks the advertisements based on specified counting criteria. For example, the system can show the most or least wanted advertised items.

The sixth step 30 of the process consists of procedures to generate activity reports. This includes an analysis process, in which the system uses the counting and ranking information to produce statistics and information. The system generates reports from the analysed information and formats it for multiple uses on multiple platforms. This information may be made available to different users or different systems, according to a predetermined hierarchy based on user access ratings.

The process for posting an advertisement is shown in more detail in FIG. 3. In step 1, the advertiser (or seller) 4 sends an SMS or MMS message 42 to the server 2 from his or her mobile phone, by calling a premium rate number. The message includes manually-entered data specified by the advertiser 4, for example including text, graphics, a video clip, specified categories, tags and price. The message also includes data that is added automatically, including the mobile phone number of the advertiser 4, which is obtained from the mobile network and serves as the advertiser's ID, and geographical location data from location based services (LBS) provided by the mobile network 10. A date/time stamp is added by the server 2. The message also includes content aggregation information (a short code and keyword). This data is all recorded in a database on the server 2.

The mobile originated (MO) call from the advertiser 4 is charged at a premium rate, generating income (for example 4E.50) that is shared between the mobile advertising service provider and the mobile network provider.

The interaction between the advertiser 4 and the server 2 is controlled by the application program interface (API) 43 of the server 2.

In response to the advertiser's message, the server 2 allocates a reference ID to the advertisement and sends an SMS message 44 back to the advertiser 4 to confirm the data and the charge. If the original advertiser's message includes any errors, the server also prompts the advertiser to correct these. The server message 44 also asks the advertiser 4 to confirm whether or not they wish the server to add tags to the advertisement to aid searching. These searchable tags are generated automatically by the server 2, based on the keywords and/or classifications specified by the advertiser 4.

In the second step of the process, if the advertiser 4 chooses to include the automatically generated tags, he sends a second SMS text message 46 back to the server 2 to confirm this. This mobile originated call is also charged at a premium rate, generating income for the server and the mobile network. The server recognises the advertiser from his/her mobile phone number, so avoiding the need for an additional identification code. The server also recalls from the database data identifying the stage of the dialogue with the advertiser, thus allowing it the continue in a logical manner. This process is referred to “persistence of session”. The server 2 responds with a second confirmation SMS message. This message 48 asks the advertiser 4 whether they wish to include geographical location data in the advertisement, this location data being obtained from the location based services (LBS) provided by the mobile network 10.

In the third step, if the advertiser 4 wishes to include geographical data in the advertisement, the advertiser 4 sends a third SMS text message 50 to the server 2, and is again charged accordingly. Finally, the server 2 sends a confirmation text message 52 back to the advertiser 4. The server 2 then sorts the advertisement and stores it in a library system on the database 8 and prepares the advertisement for listing. The entire process for posting an advertisement may therefore be concluded in three or fewer SMS/MMS messages from the advertiser 4. The process may however include additional process steps. For example, the advertiser may be asked whether they wish to include personal contact details in the advertisement, or to provide that information only upon receiving a valid response, or to hide the information entirely.

FIG. 4 illustrates an example of an internet portal that may be used by responders 6 for searching through published advertisements for any items of interest to the responder. The website provides a listing of advertisements, which may be filtered by various methods, for example by category, location, date, mobile network or keyword. In the example, the categories are MADbazar which lists general items for sale, MADhouse which lists houses for sale, MADlife listing lifestyle products, for example tickets to entertainment events, MADwheels listing motor vehicles for sale, MADworks listing services offered, and MADults which lists advertisers seeking a personal relationship with another person. The category may be selected by clicking various category headers 54, or alternatively by selecting from a drop-down list 56. The prefix “MAD”, which is abbreviation for “mobile advertising”, is merely a trade mark and has no other significance.

The listing may also be filtered by location using a drop-down list 58, by date using an archive list 60, or by country by selecting from a list of networks 62.

A search can also be conducted by entering a keyword in a search box 64. The results generated by the search can be filtered by selecting one or more buttons representing all posts 66, only the local province 68, only the present category 70 and/or only the present week 72.

If the responder wishes to receive automatic updates for advertisements meeting certain specified criteria, this can be achieved by clicking on a link 74 to provide an RSS feed. This takes the responder to a new page (not shown) in which various search filters can be specified.

The internet portal includes a listing area 76 that contains a listing of all advertisements meeting the specified search criteria, in chronological order (the most recently posted adverts appearing at the top of the list). Each advertisement 78 includes a picture 80, a text description 82 of the product, service etc. and an identification code 84 that must be specified by the responder in order to obtain further details about the advertisement, including details of how to contact the advertiser. The advertisement also includes a date stamp 86 indicating when the advertisement was posted and links 88 that may be used to save the advertisement to a basket, to remove the advertisement from the list, to create a permanent link to the advertisement or to report spam.

FIG. 5 illustrates a process for handling a response received from a responder 6, requesting more information in relation to a particular advertisement. The responder (or buyer) 6 receives a list of advertisements from the server 2 via the internet 12. In order to obtain more information in relation to a particular advertisement, optionally including the contact details of the advertiser 4, the responder 6 sends an SMS message 90 to the server 2 via the mobile network 10. This message 90 includes an identification code that identifies the advertisement in which the responder is interested. The message also includes the mobile telephone number of the responder 6, which enables the server 2 to identify the responder and respond in a logical manner. All communication between the responder 6 and the server 2 is controlled by the application program interface (API) 92, which ensures persistence of session in all communications between the server and the user.

The responder's SMS response message 90 is sent as a mobile originated message 90 and is charged at a premium rate (for example [symbol] 0.50), which creates income for the advertising service provider and the mobile network provider. Upon receiving the response message 90, the server 2 looks up the full advertisement details in the database 8, optionally including the contact details of the advertiser 4, and sends these to the responder 6 as an SMS message 94 via the mobile network 10. The server 2 also sends an SMS message 96 to the advertiser 4 via the mobile network 10, which optionally contains the mobile number of the responder 6. This allows the advertiser 4 and the responder 6 to contact one another and negotiate a transaction, either directly or via the server.

FIGS. 6 and 7 illustrate a process for sending an SMS message containing details of an advertisement to a third party (a “friend”). The process, referred to as the “send a friend” (or SAF) dialogue can be instigated by the responder 6 from the website, by clicking on a SAF link. This takes the responder 6 to a new page 98 as shown in FIG. 6, that includes dialogue boxes for the responder 6 to enter his name 100, a message 102 and the mobile phone number 104 of the friend. It also includes the details 108 of the text message that will be sent. After entering these details, the responder 6 clicks the “send” button 110. This takes the responder to the next page 102, which includes instructions asking the responder 6 to send a text message including the word SAF as confirmation to the server. This allows the server 2 to charge to responder 6 for sending the advertisement to the friend, if it is accepted.

The steps of the SAF dialogue including the billing method are shown in more detail in FIG. 7. The responder 6 sends his name, a message and the friend's mobile number as described above to the server 2 via the internet, followed by the SMS message 114 that includes the code SAF. Upon receiving these messages the server 2 sends an SMS message 116 to the friend 118 and asks the friend to confirm that they wish to receive the advertisement by returning an SMS message 120 containing the text “OK”. When the OK message 120 is received, the server 2 sends an SMS message 122 that contains the advertisement details to the friend 118. At the same time a mobile terminated message 124 is sent to the responder 6, allowing the server to charge the appropriate fee to the responder's mobile phone account. If the OK message 120 is not received within a timeout period, details of the advertisement are not sent to the friend 118 and the responder 6 is not charged.

FIG. 8 is a system diagram illustrating operation of an advertising system according to one embodiment of the invention. The advertiser 4 posts an advertisement on the server 2 by SMS or MMS message. The server 2 saves the advertisement, this process including accepting, correcting and storing the advertisement. It then sorts the advertisements, which includes indexing, classifying and sorting. It then carries out a listing process, which involves listing, publishing and selecting the advertisements. The listing is then sent to a publisher 12, for publication online (via the internet), in print and/or by television.

The responder 6 interacts with the system using the mobile network, by sending and receiving SMS and/or MMS messages. The responder is identified by his or her mobile phone number, which is obtained from the mobile network. The server 2 connects responders (buyers) with advertisers (sellers), storing their details, selecting advertisements of interest and sharing contact details. It also measures responses, which includes counting, flagging and rating the responses. In addition, the server 2 reports activity, which involves counting, analysing, formatting and publishing the results of that analysis.

FIG. 9 is a system diagram illustrating operation of an alternative second system according to the invention. This system is similar to that shown in FIG. 8, but it includes additional processes for profiling, matching and transacting buyers and sellers.

FIG. 10 is a flow diagram illustrating a process for handling incoming SMS text messages. The incoming SMS message 130 must contain an instruction plus a valid identification code (or adcode) identifying a specific advertisement. Steps 132 to 148 relate to dialogue between the server and an advertiser, and steps 150 to 180 relate to dialogue between the server and a responder.

At step 132 the system looks for the instruction MADprice. If it finds that instruction it checks at step 134 for a valid adcode and at step 136 returns an SMS containing the price of the item/service advertised. If the message does not contain a valid adcode, the server returns an error SMS to the sender at step 138.

At step 140 the system looks for a keyword, which in this example is the instruction MAD. If it finds that instruction it checks at step 142 for a valid adcode and at step 144 returns an SMS containing the contact mobile phone number of the advertiser. If the message does not contain a valid adcode, the server returns an error SMS to the sender at step 138.

At step 146 the system looks for the instruction MADalert start or MADalert stop, plus an indication of category. If it finds that instruction it responds at step 148 by starting or stopping an alerting service in the specified category. The alerting service consists of sending RSS feeds to the sender containing details of new advertisement listing in the specified category.

At step 150 the system looks for the instruction MADsold. If it finds that instruction it checks at step 152 for a valid adcode and checks at step 154 that the message 130 was sent from the same mobile phone number as that recorded against the specified advertisement. If both of these steps return “yes” then at step 156 the server sets the status of the advertisement to “sold”. If either of steps 152 and 154 returns “no”, the server returns an error SMS to the sender at step 138.

At step 158 the system looks for the instruction MADtop, at step 160 it looks for a valid adcode and then at step 162 it responds by placing the specified advertisement at the top of the listing. If the message does not contain a valid adcode, the server returns an error SMS 138.

At step 164 the system looks for the instruction MADkey* plus one or more keywords defined by the advertiser. At step 166 it checks for a valid adcode and at step 168 it responds by including the keywords in the specified advertisement. If the message does not contain a valid adcode, at step 170 the server checks that an SMS was received from the same mobile number within the last twenty minutes and, if so, it includes the keywords 168. If step 170 is not satisfied, the server returns an error SMS to the sender at step 138.

At step 172 the system looks for the instruction MADprice* plus a price defined by the advertiser. At step 174 it checks for a valid adcode and at step 176 it responds by including the new price in the specified advertisement. If the message does not contain a valid adcode, at step 178 the server checks that an SMS was received from the same mobile number within the last twenty minutes and, if so, it includes the new price 176. If step 174 is not satisfied, the server returns an error SMS to the sender at step 138.

If all of steps 132, 140, 146, 150, 158, 164, 172 and 180 return a negative response, the server defaults to the process for creating a new advertisement at step 180.

Optionally, the mobile advertising system includes a social valuation system (SVS), which allows a social value to be assigned to individual advertisements, where the “social value” (relating for example to price, privacy or the community) is set by users of the system. The principles underlying the SVS in each of these contexts are described below.

Price: In an online virtual marketplace, or a classified advertising website, the right price is often the key to the deal, but not always. In this context, the Social Valuation System (SVS) is designed to find the “right” price by using collaborative social interaction.

A seller will want to get the right price for an item, and a buyer will not want to pay too much. The problem that buyers and sellers face is how to find the right price. The SVS facilitates an interactive SMS text dialogue between buyers and sellers to find the right price.

Privacy: Using publicly accessible websites for advertising goods or services means that the listed information is available online for everyone to see at any time. However, advertisers may wish to withhold private and valuable information (e.g. personal contact details) on these public sites and only reveal this information using SMS text message to selected responders to their advertisement. Such hidden information has a real value when separated from the public parts of the advertisement e.g. responders to a “meet me” type advertisement will only get to find out where the secret meeting place is by receiving a SMS text message after they have responded. Using the SVS the advertiser can select whether or not to send the hidden information to all responders or only to specifically selected responders. The SVS allows the advertiser to divide the advertisement into portions or “micro chunks” and manage the release of higher value information.

Community: Feedback from the community can increase or decrease the value of an advertised item or service. The SVS facilitates the capture of comments via SMS and MMS messages and manages the subsequent publishing of this feedback.

The application of the SVS in a buying and selling process will now be described in more detail.

The three activities in the buying or selling process are:

1. Preparation and Research

2. Trading or Bidding

3. Fulfillment

The PLR system described above concentrates on the preparation and research phase. The PLR system is not a transactional system or an online auction. The SVS creates value for buyers and sellers through social interaction and collaboration. The community takes part in the process using SMS and MMS messaging via the system.

The PLR system provides added value to stimulate the classified advertising community through the integration of online and mobile technologies and collaborative social networking.

Users of the service pay a small premium for each SMS or MMS message. These messages drive the three functions of the advertising system:
1. Placement of an ad: using PLR technology
2. Tagging of an ad: using DCS technology
3. Valuing an ad: using SVS technology

PLR: The Posting/Listing/Responding system allows users to create, send, list, and respond to advertisements using SMS, MMS and location based services.
Function: a user can immediately advertise on the system and its affiliate channels.
Advantages: quick, easy, simple, fun, mobile, immediate, user friendly.

DCS: The Dynamic Classification System facilitates the capture of user provided and system generated metadata using tagging and cluster technologies.
Function: real time indexing and dynamically created categories.
Advantages: spontaneous and immediately reacting to the community input and social popularity.

SVS: The Social Valuation System allows users to value listed items and facilitates feedback capture and presentation.
Function: “micro chunk” the advertisement and manage the release of information.
Advantages: interactive and bidirectional creation of social community value.

Operation of the SVS system will now be described in more detail.

During the PLR process the user sends SMS and MMS messages to the system through the mobile operator's networks. These messages will contain the content of the advertisement that will be published. In addition the user may choose to “tag” the advertisement. These tags will be used for Dynamic Classification and to create social “Value” for the advertised item or service.

Price Valuation: To give the advertised item, or service, a price “Value” the user is presented with a choice to state a price or to invite offers. The advertiser is asked to respond with either the “actual price” of the item, or service, or to send the SMS text message “offer”.

Social Valuation: To give the advertised item, or service, a non monetary value the user would complete the PLR process by sending the SMS text message “HIDE” followed by the valuable information e.g. when advertising for a car share the advertiser would send the SMS text message “HIDE FOR LATE NIGHT COMMUTING” where the information is hidden regarding the time of day when a car share is required. The system will indicate next to the advertisement that there is more information available. This information can be obtained by responding to the advertisement using SMS text message.

These are the basic three steps to using the PLR service.

1) CREATE AD: The advertiser sends an SMS or MMS containing a TXT of the ad description, or a picture or video message, to the server, which responds with a TXT confirming receipt. The advertiser does not include their mobile number or the price at this stage.

2) TAG AD: The advertiser sends a TXT to confirm or to modify their location tag and/or advertisement tags (keywords), so that the system can categorise the advertisement. The advertiser can create their own categories, if required.

3) VALUE AD: The advertiser sends a TXT that either sets a target price or requests offers. The advertiser's mobile number and target price are hidden, but may optionally be revealed via TXT to responders. Offers are displayed on the website.

Use is further illustrated by the following examples:

Scenario 1—Fixed Target Price

In this scenario the advertiser specifies (via SMS text message in step 3 above) the target price they wish to achieve. This can be for a sale, a wanted item or a service. For example the advertiser may wish to purchase a particular make and model of golf club and have a budget of £150. So the advertiser would text the message “PRICE 150” to the server. This price will remain hidden on the publishing portals but will be revealed by return SMS text message to any responders to the advertisement. To respond to the advertisement and obtain the target price value, the responder sends an SMS message to the server quoting the advertisement unique identifier or “ad id”. For example, a responder would send the text message “wrteghd”, where “wrteghd” is the unique ad id, and in reply the server would reveal the target price. In this example, the mobile phone numbers for the advertiser and responder are exchanged via SMS text message when a response is received. Once the price and contact information have been revealed to the advertiser and responder they are free to contact each other directly and complete their negotiations and reach a deal.

Scenario 2—Inviting Offers (Community Valuation)

In this scenario the advertiser tells the system (via SMS text message in step 3 above) to request offers from responders. This can be for a sale, a wanted item or a service. For example the advertiser may wish to purchase a particular make and model of golf club and have a budget of £150. The advertiser would text the message “OFFERS” to the system. This invitation for offers will be displayed on the server alongside the advertisement and responders will be able to send their offers to the system by SMS text message. The offer prices will be forwarded to the advertiser. The mobile phone numbers for the advertiser and responder are exchanged via SMS text message when a response is received. To respond to the advertisement, the responder sends an SMS message to the system quoting the advertisement unique identifier or “ad id” and the offer price. For example, a responder would send the text message “wrteghd 120” to the system, where “wrteghd” is the unique ad id and “120” is the offer price.

The offer price is listed on the system along with any other offers received for that advertisement. Since there is no binding agreement between advertiser and responder, the weighting of the offer values is a true and real time reflection of the market, or in other words the social value of the advertised item or service as decided by the community. Other users can collaborate or compete to manipulate the publicly listed offer prices up or down.

In addition, the responders may add comments in their text message after their offer price. These comments will be displayed alongside the advertisement on the system.

The following is an example of an “OFFERS” history, with comments, for an advertisement on the system:

| Date | Time | Offer Value | Comment |
|---|---|---|---|
| Today | 9:06 am | £125 | I am local and have cash |
| 2 days ago | 10:20 pm | £90 | I think this is an old model |
| 3 days ago | 11:45 am | £140 | This is cheap, is it genuine? |

Scenario 3—Hidden Tag (Social Differentiation)

In this scenario the advertiser tells the system (via SMS text message in step 3 above) to hide a tag on the server. This can be for a sale or wanted item or a service. For example the advertiser may wish to contact and meet people with a similar interest but wants to avoid sharing a meeting location online so that only genuinely interested responders will get to know the meeting location. The advertiser would text the message “HIDE RISING SUN CAFÉ 2PM TOMORROW” to the system. Alongside the advertisement on the server will be the logo TMM “Tell Me More” and responders will be able to discover the hidden tag information by SMS text message. The mobile phone numbers for the advertiser and responder may be exchanged via SMS text message when a response is received, or they may remain hidden. To respond to the advertisement the responder sends an SMS message quoting the advertisement unique identifier or “ad id”. For example; a responder would send the text message “wkkeghd”, where “wkkeghd” is the unique ad id. The system then forwards the hidden tag to the responder, in this case “RISING SUN CAFÉ 2PM TOMORROW”.

Only responders who want the meeting location information will spend the money on a premium SMS text message. This “values” the hidden information. Members of the community who see less value than the cost of the premium rate SMS text message will not be prepared to respond and therefore will not see the hidden tag information.

The advantage for the advertiser is that the SVS filters out nuisance and casual responses and focuses on responders with a genuine interest.

Additionally, as an option, the “comments” function can be added to the advertisement. For example, the system can be used as a billboard for other users to post additional information about the advertisement.

| Date | Time | Comment |
|---|---|---|
| Today | 9:06 am | Can't wait to see you tomorrow - I am Dave the |
| | | pianist |
| 2 days ago | 10:20 pm | I prefer the cinema trips to the restaurant meetings |
| 3 days ago | 11:45 am | I really enjoyed the last meeting |

This creates a social or closed community value to the advertisement content.

In conclusion, the Social Valuation System enables the community to decide the value of an item or service. The “comments” provide contextual value to the offers and advertisement content.

SVS advantages for the advertiser:
does a reality check on a fixed price
researches the correct “market or community” price
solicits community valuation and comments

SVS advantages for the responder:
provides feedback on the value of the item (and forces correction)
facilitates a collaborative group, influencing the price of an item
shares commentary regarding the advisement content or advertiser

FIG. 11 is a schematic diagram of the advertising system infrastructure according to a another embodiment of the invention. The system, which is referred to in the drawings by the trade name “MOBIYA”, includes a message send/receive processor (SRP) 200, a message central processor unit (CPU) 202, an internet portal 204, a set of web databases 206, a messages database 208, a temporary message database 210 for recording data from external calls 212, and a set of administrator modules 214.

The message SRP 200 controls communications with users via one or more SMS/MMS service providers 216 (for example, Paratel™ or Opera™), which are connected to a SRP logic unit 218 through a communications module 220. The message SRP 200 also communicates with the message CPU 202 through a second communications module 222.

The message CPU 202 includes a command engine 224, which communicates with the message SRP 200 through a workflow manager 226, a control unit 228, a message parser 230 for incoming messages and a message sender 232 for outgoing messages. The command engine 224 is also connected to the message database 208, where data relating to messages that have been sent and received is stored.

The web portal 204 is also connected to and controlled by the command engine 224, and includes web server logic 234 and a database services module 236, which controls the flow of data to and from the web databases 206. The three sets of databases 206, 208, 210 are all connected to the administration modules 214, which allow an administrator to access and modify the data held in the databases.

FIG. 12 illustrates a typical web portal for web-based advertisements, according to an embodiment of the invention. The portal may be used by responders for searching through published advertisements for items of interest. The website provides a listing of advertisements, which may be searched by various methods, for example by location, date, or keyword (tag).

The listing may also be filtered by location, by selecting a location from a list of regions 240 or a list of popular locations 242. Each of these lists is ranked in order of popularity: that is, by the number of advertisements associated with that particular location (this number being shown against each location). The lists may be extended to show more locations by clicking a “more” button 244.

Alternatively, the listing of advertisements may be filtered by search category, by selecting from a list of “most popular” tags 246 or a list of “most wanted” tags 248. The “most popular” list 246 shows the tags that appear most frequently in advertisements listed on the system, together with a number indicating how many times each of those tags appears. These are ranked by popularity, the most popular tags appearing at the top of the list. More tags can be seen by clicking a “more” button 244. Clicking one of the tags generates a list of all the adverts that include that tag.

The “most popular” list 246 allows users to assess the level of supply for items and services listed on the system, and to identify the tags that are used most frequently to identify those items. It also allows users to see easily which tags are most popular for particular items. Advertisers and responders can then choose to select those tags, ensuring a degree of uniformity and consistency among users.

The “most wanted” list 248 shows the tags that appear most frequently in advertisements that have generated a response from a responder, together with a number indicating how many responses each of those tags has generated. These are also ranked, the most wanted tags appearing at the top of the list. More tags can be seen by clicking a “more” button 244. Clicking one of the tags generates a list of all the adverts that include that tag.

The “most wanted” list 248 allows users to assess the level of demand for items and services that are currently listed on the system, and to identify the tags that are being used most frequently to identify those items. This is useful for advertisers with items to sell, as it allows them to assess the current level of demand for those items and set a price accordingly. It also allows them to see easily which tags are most likely to generate responses.

The website also includes a date list 250, which lists advertisements according to the date on which they were placed on the system. The number of advertisements placed on each day is also indicated. Users can view all the advertisements placed on a particular day by clicking one of the dates on the list.

A search can also be conducted by entering a keyword in a search box 252 then clicking a “go” button 254. An advanced search screen that allows the results to be filtered, for example by restricting the list of results to those in the local region, can be accessed by clicking an “advanced search” button 256.

If the responder wishes to receive automatic updates for advertisements meeting certain specified criteria, this can be achieved by clicking on a link 258 to provide an RSS feed. This takes the responder to a new page (not shown) in which various search filters can be specified.

The website includes a listing area 260 that contains a listing of advertisements 262 meeting any specified search criteria. Each advertisement 262 includes a description 264 of the product, service etc., an indication of the age of the advert 266, optionally a category 268 (e.g. marketplace, classifieds or personals), the geographic location 270, the price 272 (of appropriate) and optionally a link 274 to an image or an audio or video clip. Each advert also includes a response counter 276 that indicates how many responses that advert has generated, an identification code 278 that must be specified by the responder when responding to the advertisement, a link 280 to a list of the tags attached to that advert, a link 282 to send the advert to a friend, and a link 284 for responding to the advert.

FIG. 13 is a flow diagram showing the steps of a process for placing and responding to an advertisement, according to a second embodiment of the invention. The steps of the process are as follows:
1. Advertiser creates advertisement containing text, images and video and sends to system.
2. System sustains SMS/MMS conversation to collect more data from advertiser, and meta data from mobile network.
3. System quarantines (hides) specific advertisement data, meta data and contact information.
4. System formats, indexes and ranks advertisement content and meta data and updates counters.
5. System bills advertiser over SMS, MMS and mobile payments systems.
6. System publishes advertisement with optimised search via indexing and ranking using counters.
7. Responder responds to advertisement over SMS and MMS.
8. System sustains SMS/MMS conversation to collect more data from responder and mobile network operator.
9. System formats, indexes and ranks responder message content and meta data and updates counters.
10. System formats and publishes updated advertisements including updated response counters.
11. System bills responder over SMS, MMS and mobile payments systems.
12. System looks up rules list to determine next step e.g. release quarantined or hidden data or contact information.
13. Responder receives systems messages and advertiser data and quarantined information.
14. Advertiser receives systems messages and responder data and quarantined information.
15. System bills responder over SMS, MMS and mobile payments systems.
16. System bills advertiser over SMS, MMS and mobile payments systems.

Steps 1, 2, 4, 5, 7, 8, 10, 11, 15 & 16 relate to the Posting, Listing and Responding (PLR) system. This is an automated and configurable module that intelligently sustains a conversation with the advertiser and responder. Dialog in the conversation is dependent upon the incoming SMS and MMS messages from the advertiser or responder. Content and metadata are processed, converted and then broadcast over the system interfaces to online and/or offline media. Unique functionality includes persistence of session where a user is recognized and the dialog with that user is controlled to ensure it is in context to their status and the stage in the advertising or responding process. Other functions may include embedding Location Based Services, providing automatic dialogues, forward and reverse billing for all media types, and mobile operator interfaces, etc.

Steps 6 & 9 relate to the Dynamic Classification System (DCS). This system deals with the capture of context and content, the indexing and ranking of that data and the search functions. This system provides a real time view of the market supply and demand for any given item or service, and provides an automatic feedback mechanism to advertisers and responders about market activity and methods for optimizing content visibility and searching. This whole process is based on user generated categorization (indexing) combined with location and operator data, using a folksonomy-based approach to ranking.

Keywords or “tags” are used by advertisers to categorize advertisements and by responders to respond to advertisements. These “tags” are treated as meta data. Mobile operators also provided data such as source and destination mobile numbers, sender location, message time and message date, and this information is also treated as meta data. Meta data including tags and their synonyms are grouped together in “clusters”. Advertiser activity and responder activity will increment counters assigned to tags and clusters. These counters are used to rank and sort advertisements and data relating to advertisers and responders by popularity. This “ranking” of the popularity of tags and clusters amongst the advertiser community and the responder community provides a real time snapshot of market supply and demand respectively.

Practical uses for the Tag and Cluster functionality in the DCS are:

a) Categorizing advertisements to ensure optimized search for potential responders, allowing users to generate their own categories. The system does not rely on a structured categorization system. The categories are user generated and controlled. For example, a music concert ticket that is for sale can be categorized with the artist's name rather than being generalised alongside other tickets in a taxonomy based category structure. Users of the system can search on individual words or groups of words, abbreviations or phrases to narrow down a search. Responding to an advertisement over SMS or MMS will increment the counters and popularise the artist's name. This will show increased market demand for such an item in the system. Likewise, multiple advertisements tagged with the artist's name will increment counters and popularize the availability of items using this tag, and will therefore indicate market supply.

b) Creating relationships between categories: clustering tags creates a relationship between tags or creates “related tags” so that users of the system searching for a specific item using a specific tag (or multiple tags) will be shown additional advertisements with “related tags” that are in the same cluster. For example, if two music artists' names are created by advertisers or responders as tags then the system may decide to relate these two tags for a given reason: e.g. they focus on the same genre of music. This means that all users searching for advertisements with one artist's name will also see a ranked and indexed list of advertisements containing the other artist's name. The unique functionality of the system is that the tags in each case have a popularity count created by individual user activity over SMS and MMS in response to the published advertisements.

Steps 3, 12, 13 & 14 relate to the Social Valuation System (SVS). This module handles the trading of data between users of the system. For example, advertisers are able to remain anonymous and decide what contact information is forwarded to responders over their adverts and vice versa. Other functionality includes bid and offer management, feedback and comment functions, and support for extended social networking and community interactivity around content.

Here is an example where a specific workflow for specific market has been defined in the system control panel. This configuration can be modified by the system administrator at any time through the system control panel.

Step 1a: A new user (an advertiser) sends their advertisement <Red Ford Focus for sale> to the shortcode 40500. This advertisement message can contain text and images and video and audio data.

Step 1b: The PLR system receives the user message and records the advertiser's mobile number, time, date, location and any other information provided by the network operator (e.g. mobile phone specifications and language etc.). Some of this data may be stored as public data and some may be stored as quarantined (hidden) data.

Step 2a: The PLR system recognizes that this is a new advertisement and publishes the advertisement text and any public meta data.

Step 2b: The PLR system sends an SMS message to the advertiser. This message contains predefined text or multimedia content: e.g. <Thank you for your advertisement that is now published. To optimize the visibility of your advertisement please categorize your ad now by responding to this message with your preferred search word(s)>.

Step 3a: The advertiser receives the system message and responds with a category choice which can be anything they want: e.g. <red fast cars>.

Step 4a: The PLR system receives the SMS message and recognizes that this is a returning advertiser. It also recognizes where this advertiser is in the predefined advertising process and their status. No keywords or ID's are necessary: this is “persistence of session” over an SMS conversation.

Step 4a: The DCS system processes the advertiser's message and uses the category information and the other advert data and meta data to index the advertisement in the database. Categories that are identical, including synonyms and categories in the same cluster of categories, together with the advertisement text and meta data provide a ranking measurement showing the popularity of specific data. This indicates the popularity in real time based on user generated content and information provided by the mobile operator. The published advertisement is updated with this additional information. This is the foundation of the DCS.

Step 4c: The PLR system sends an SMS message (predefined in the control panel as part of the workflow for this example) to the advertiser: e.g. <Thank you for your choice of key words. Please tell us if you want to fix the price or accept offers? Text your price or the word “offers” to 40500>.

Step 5a: The advertiser receives the message from the system and responds with an SMS message: e.g. <offer>.

Step 5b: The PLR system receives the SMS message and recognizes that this is a returning advertiser, where this advertiser is in the predefined advertising process, and their status. No keywords or ID's are necessary: this is persistence of session over an SMS conversation.

Step 5c: The PLR system processes the advertiser's message. In this case, the Social Valuation System is activated because the word “offers” is recognized as being an instruction to activate the SVS function, rather than a new user's advertisement text. This is due to the PLR persistence of session function.

Step 5d: The PLR system sends an SMS message to the advertiser to close the session: e.g. <Thank you for your advertisement. Your advert reference number is 123456 and you can adjust your advertisement by prefixing all commands with this ID e.g. “123456 SOLD”>.

Step 6a: A new user (a responder) sees the published advertisement with a reference 123456 and wants to make an offer. The new user sends an SMS message with their offer to the short code 40500: e.g. <123456 £350>

Step 6b: The PLR system receives the responder's message and records the responder's mobile number, time, date, location and any other information provided by the network operator (e.g. mobile phone specifications and language etc.). Some of this data may be stored as public data and some may be stored as quarantined (hidden) data.

Step 6c: The PLR system recognizes that this is a new responder and also that the responder has included an offer price in their message. The message could also have contained any other transmittable data that could be used to populate the SVS: e.g. text comments, images etc.: e.g. <123456 I think this is only worth £350>. The system transfers the relevant user's message data to the SVS system and the published advertisement is updated. The SVS information is also published.

Step 6d: The PLR system processes the responder's SMS message content and depending on the content this may trigger additional processes within the PLR, DCS or SVS that generate system messages to the responder and system messages to the advertiser, either with or without some or all of the responder data and meta data (operator or system data about the responder or their response).

Step 6e: The DCS system recognizes each unique advertiser and responder event around an advertisement and the advertisement content and meta data, and uses this to complete the indexation and ranking of the all the advertisement, advertiser and responder data. This is then used to present a ranking of the most popular data elements e.g. most advertised and most responded to items, to indicate the supply and demand dynamics of the market in real time based on qualified activity from unique mobile users. This is the output of the DCS system.

Various modifications of the system and process described above are of course possible, as will be apparent to a person skilled in the art. For example, the advertiser may place an advertisement via the internet and use his mobile phone simply to send a confirmation that he wishes to proceed with the advertisement, and for billing purposes. Although only a single server is shown in the drawings, this may be replaced by a network of linked computers. Although the examples are based on use of the mobile phone network, other compatible communication systems may also be used. Billing may also be carried out by other methods, for example by charging a bank or credit card account, or an online payment service (e.g. PayPal™), or IVR (voice response).

1. An advertising system including a server having a database for storing details of advertisements, publishing means for publishing details of the advertisements, and electronic communication means allowing the server to communicate with advertisers and responders, said system being constructed and arranged such that advertisers can place advertisements on the system and responders can view the published details of the advertisements, wherein the server is constructed and arranged to enable communication between an advertiser and a responder upon receiving a response from the responder that identifies an advertisement placed by the advertiser.

2. An advertising system according to claim 1, wherein the server includes a dynamic classification system (DCS) for classifying advertisements placed on the system, wherein the DCS is constructed and arranged to allow each advertiser to specify one or more tags that are to be attached to that advertiser's advertisement.

3. An advertising system according to claim 2, wherein the DCS is constructed and arranged to record all the tags associated with advertisements placed on the system, to obtain a popularity value for each recorded tag that represents the number of advertisements associated with that tag, to rank the tags according to their popularity values and to display one or more of the tags having the highest popularity values.

4. An advertising system according to claim 2, wherein the DCS is constructed and arranged to record all the tags associated with advertisements placed on the system, to obtain a wanted value for each recorded tag that represents the number of responses to advertisements associated with that tag, to rank the tags according to their wanted values and to display one or more of the tags having the highest wanted values.

5. An advertising system according to claim 3, wherein the number of tags associated with an advertisement includes tags attached to that advertisement and one or more additional tags that are related to the attached tags.

6. An advertising system according to claim 1, wherein the communication means is constructed and arranged to allow the server to communicate with advertisers and responders by means of data communication through a mobile phone network.

7. An advertising system according to claim 6, wherein the server is constructed and arranged to identify advertisers and responders according to their mobile phone numbers.

8. An advertising system according to claim 6, wherein the server is constructed and arranged to identify the geographical location of advertisers using mobile data services.

9. An advertising system according to claim 6, wherein the server includes billing means that is constructed and arranged to charge for use of the system by charging advertisers and/or responders for sending and/or receiving data messages via the mobile phone network.

10. An advertising system according to claim 6, in which the publishing means is constructed and arranged to push details of advertisements to responders via the mobile phone network.

11. An advertising system according to claim 1, in which the server is configurable to publish personal contact details allowing direct communication between the advertiser and the responder, or to hide those details, or to provide those details only in specific circumstances.

12. An advertising system according to claim 1, in which the publishing means is constructed and arranged to publish details of advertisements via the internet.

13. An advertising system according to claim 1, in which the stored details include public data and hidden data, the server being constructed and arranged to provide hidden data to a responder only upon receiving a response from the responder.

14. (canceled)

15. (canceled)

16. (canceled)

17. (canceled)

18. An advertising process including receiving advertisement details from advertisers, storing the advertisement details in a database, publishing details of the advertisements, receiving responses from responders, and allowing communication between an advertiser and a responder upon receiving a response from the responder that identifies an advertisement placed by the advertiser.

19. An advertising process according to claim 18, including classifying advertisements placed on the system by allowing each advertiser to specify one or more tags and attaching the tags to that advertiser's advertisement.

20. An advertising process according to claim 19, wherein classifying the advertisements includes recording all the tags associated with advertisements placed on the system, obtaining a popularity value for each recorded tag that represents the number of advertisements associated with that tag, ranking the tags according to their popularity values, and displaying one or more of the tags having the highest popularity values.

21. An advertising process according to claim 19, wherein classifying the advertisements includes recording all the tags associated with advertisements placed on the system, obtaining a wanted value for each recorded tag that represents the number of responses to advertisements associated with that tag, ranking the tags according to their wanted values, and displaying one or more of the tags having the highest wanted values.

22. An advertising process according to claim 19, wherein the number of tags associated with an advertisement includes tags attached to that advertisement and one or more additional tags that are related to the attached tags.

23. (canceled)

24. (canceled)

25. (canceled)

26. (canceled)

27. (canceled)

28. (canceled)

29. (canceled)

30. (canceled)

31. (canceled)

32. An advertising process according to claim 18, including categorising advertisements automatically and dynamically.

33. An advertising process according to claim 18, including generating a classification system based on data contained in the advertisements.

34. (canceled)

35. (canceled)

36. (canceled)

37. (canceled)
